(19) United States
(12) Patent Application Publication
(10) Pub. No.: US 2014/0086214 A1
(43) Pub. Date: Mar. 27, 2014

(54) MACHINE TYPE COMMUNICATION DEVICE, AND THE SERVICE METHODS THEREFOR

(71) Applicant: Electronics and Telecommunications Research Institute, Daejeon (KR)

(72) Inventors: Yong Geun HONG, Daejeon (KR); Hyoung Jun KIM, Daejeon (KR)

(73) Assignee: Electronics and Telecommunications Research Institute, Daejeon (KR)

(21) Appl. No.: 14/012,439

(22) Filed: Aug. 28, 2013

(30) Foreign Application Priority Data
Aug. 28, 2012 (KR) 10-2012-0094503

(51) Int. Cl. H04W 4/00

(52) U.S. Cl. CPC H04W 4/005
USPC 370/332; 370/331

(57) ABSTRACT

The present invention relates to a machine type communication (MTC), and more particularly, to an MTC device and a method of providing an MTC service that may determine the entry of an MTC device with respect to a service area of each of a plurality of wireless communication networks and thereby selectively connect to a wireless communication system in an MTC system configured to connect the MTC device and an MTC server over the plurality of wireless communication networks.

### CROSS-REFERENCE TO RELATED APPLICATION(S)

This application claims the benefit of Korean Patent Application Nos. 10-2012-0094503, respectively filed on Aug. 28, 2012, in the Korean Intellectual Property Office, the disclosures of which are incorporated herein by references.

### TECHNICAL FIELD

The present invention relates to a machine type communication (MTC) and, more particularly, to an MTC device and a method of providing an MTC service that may determine the entry of an MTC device with respect to a service area of each of a plurality of wireless communication networks and thereby selectively connect to a wireless communication system in an MTC system configured to connect the MTC device and an MTC server over the plurality of wireless communication networks.

### BACKGROUND ART

A machine type communication, which is known as machine-to-machine (M2M) communication or MTC, refers to a technology of equipping a wireless terminal with a plurality of wireless communication tools, such a wireless local area network (WLAN) and a 3^{rd} Generation (3G)/4^{th} Generation (4G) communication network, and providing an information service from a service server to the wireless terminal using the plurality of communication tools. In the case of machine type communication (MTC), technologies for providing a selective connection and a continuous service between a service server and a mobile wireless terminal are being developed since a wireless terminal of a user using a service has mobility with respect to a plurality of wireless communication tools.

As a related art, FIG. 1 illustrates “Wireless Communication System and its Method, and Device and Program Used for Same” disclosed in Korean Patent Publication No. 10-2009-0039769 A. This technology relates to a wireless communication control method, apparatus, and system that enable a terminal device connectable to a plurality of wireless communication networks to efficiently select a communication network. Here, wireless local area network (WLAN) base station devices are monitored by a WLAN base station monitoring server device, and each notifies the WLAN base station monitoring server device of WLAN base station information on themselves. A combined wireless terminal device which is to initiate communication requests WLAN base station information on a connectable WLAN base station device. The WLAN base station monitoring server device notifies the combined wireless terminal device of information on whether the connectable WLAN base station device is present and if any, corresponding WLAN base station information according to information acquired from the combined wireless terminal device having requested the WLAN base station information, via a 3G network. The combined wireless terminal device receives the WLAN base station information, and determines whether to set up a connection to a corresponding WLAN network based on the received WLAN base station information. However, in the above technology, the combined wireless terminal device is only configured to determine a connection to the wireless LAN network and thus, may not adapt to a change in a communication environment according to migration of the combined wireless terminal device after the connection. Further, there is a need to additionally include the WLAN base station monitoring server device for monitoring the WLAN base station device. Accordingly, system cost may increase.

As another relate art, FIG. 2 illustrates “Fixed Mobile Convergence (FMC) architectures” disclosed in Korean Patent Publication No. 10-2011-0017893”. This technology relates to an apparatus and method for setting up a connection to a subscriber connection network such as a 3G network over an untrusted network such as a WLAN. A stream ID is assigned to a mobile device when the mobile device is initiated. The stream ID remains in an active state until the mobile device powers down, loses WLAN coverage, or is deregistered from a network. All of voice and data calls may be routed through a tunnel using the assigned stream ID. However, in the above technology, only the stream ID is assigned to the mobile device. Accordingly, when the mobile device loses the WLAN coverage due to a change in a communication environment such as migration of the mobile device or is de-registered, a data service is suspended and a mobile device ID needs to be reassigned.

As still another related art, FIG. 3 illustrates “Method and Apparatus for Hand off between Mobile Communication Network and WLAN” disclosed in Korean Registration Patent No. 10-0770860. This technology relates to a method for hand off between a mobile communication network and a WLAN and an interworking apparatus, including a router configured to route data traffic from an Internet network to a terminal, to a first node of a mobile communication network, the first node configured to route the data traffic to a second node of the mobile communication network or an access router of a WLAN based on whether a call of the data traffic received from the router is established with respect to the mobile communication network, the access router connected to the router and the first router to transmit the data traffic from the first node to the terminal and to transmit data traffic from the terminal to the router, the second node configured to transmit and receive the data traffic received from the first terminal to the terminal located in the mobile communication network, and a dynamic host configuration protocol (DHCP) server configured to support a terminal having handed off to the mobile communication network or the WLAN to use an IP assigned before hand off even after the hand off. However, in the above technology, when a terminal located in the mobile communication network hands off to the WLAN, the terminal is configured to use an IP assigned from a dynamic configuration host protocol (DCHP) server. Also, when a terminal located in the WLAN hands off to the mobile communication network, the terminal is configured to use an IP assigned from the DHCP server. Accordingly, IP management of a terminal may be difficult and thus, management of a plurality of terminals on a service server may become massive and complex.

### REFERENCES OF RELATED ART

### Patent References

(Patent Reference 1) KR10-0605934 B1
(Patent Reference 2) KR10-0770860 B1
(Patent Reference 3) KR10-0617795 B1
(Patent Reference 4) KR10-0879149 B1
(Patent Reference 5) KR10-2009-0039769 A
(Patent Reference 6) KR10-2011-0030491 A
(Patent Reference 7) KR10-2011-0017893 A
(Patent Reference 8) WO2008020536 A1
(Patent Reference 9) WO2009148973 A1
(Patent Reference 10) WO2009155005 A1
(Patent Reference 11) US20060114874 A1
(Patent Reference 12) US7441043 B1
(Patent Reference 13) US7693522 B2

### DISCLOSURE OF INVENTION

### Technical Goals

An aspect of the present invention provides a machine type communication (MTC) device and a method of providing an MTC service that may assign a fixed device ID to an MTC device and thus, may not require management of a separate ID such as a floating IP according to a service connection.

Another aspect of the present invention also provides an MTC device and a method of providing an MTC service that enables an MTC gateway device and an MTC server to verify entry and hand off of an MTC device with respect to an MTC capillary device and thereby, enables an efficient MTC service.

### Technical Solutions

The present invention provides a machine type communication (MTC) device in an MTC system for providing a service by providing a first network having a wide coverage and a low bandwidth and a second network having a local coverage and a high bandwidth and by connecting an MTC device 100 and an MTC server, and a method of providing an MTC service, the MTC device including: a first network communication unit configured to communicate with the first network having the wide coverage and the low bandwidth; and a second network communication unit configured to communicate with the second network having the local coverage and the high bandwidth. A first signal strength detector configured to detect strength of a communication signal of the first network may be provided to the first network communication unit to thereby provide the strength of the communication signal of the first network to a controller. A second signal strength detector configured to detect strength of a communication signal of the second network may be provided to the second network communication unit to thereby provide the strength of the communication signal of the second network to the controller. The first network communication unit and the second network communication unit may be selected through a transmission/reception switch to transmit data provided from the controller as a selected communication unit or to provide received service data, and may include an MTC server identifier (ID) storage configured to store an ID of each of at least one MTC server, and a device ID storage 160 configured to store an ID of the MTC device 100, to thereby be provided with a service.

### Effects of the Invention

According to embodiments of the present invention, there may be provided a machine type communication (MTC) device and a method of providing an MTC service that may assign a fixed device ID to an MTC device and thus, may not require management of a separate ID such as a floating IP according to a service connection.

Also, according to embodiments of the present invention, there may be provided an MTC device and a method of providing an MTC service that enables an MTC gateway device and an MTC server to verify entry and hand off of an MTC device with respect to an MTC capillary device and thereby, enables an efficient MTC service.

### BRIEF DESCRIPTION OF DRAWINGS

FIG. 1 illustrates a configuration of a wireless communication system and its method, and a device and a program used for the same according to a related art.

FIG. 2 illustrates a configuration of fixed mobile convergence (FMC) architectures according to another related art.

FIG. 3 illustrates a configuration of a method and apparatus for hand off between a mobile communication network and a wireless local area network (WLAN) according to still another related art.

FIG. 4 illustrates an example of a configuration of a machine type communication (MTC) system.

FIG. 5 illustrates another example of a configuration of an MTC system.

FIG. 6 illustrates the technical spirit of a configuration of an MTC system of the present invention.

FIG. 7 illustrates a configuration of an MTC device of the present invention.

FIG. 8 illustrates an example of an MTC service in a case in which an MTC device of the present invention enters service areas of a first network and a second network and a request for an MTC service occurs.

FIG. 9 illustrates another example of an MTC service in a case in which an MTC device of the present invention enters service areas of a first network and a second network and a request for an MTC service occurs.

FIG. 10 illustrates still another example of an MTC service in a case in which an MTC device of the present invention enters service areas of a first network and a second network and a request for an MTC service occurs.

FIG. 11 illustrates an example of an MTC service in a case in which an MTC device of the present invention hands off a service area of a second network while receiving an MTC service in the service area of the second network.

FIG. 12 illustrates another example of an MTC service in a case in which an MTC device of the present invention hands off a service area of a second network while receiving an MTC service in the service area of the second network.

FIG. 13 illustrates still another example of an MTC service in a case in which an MTC device of the present invention hands off a service area of a second network while receiving an MTC service in the service area of the second network.

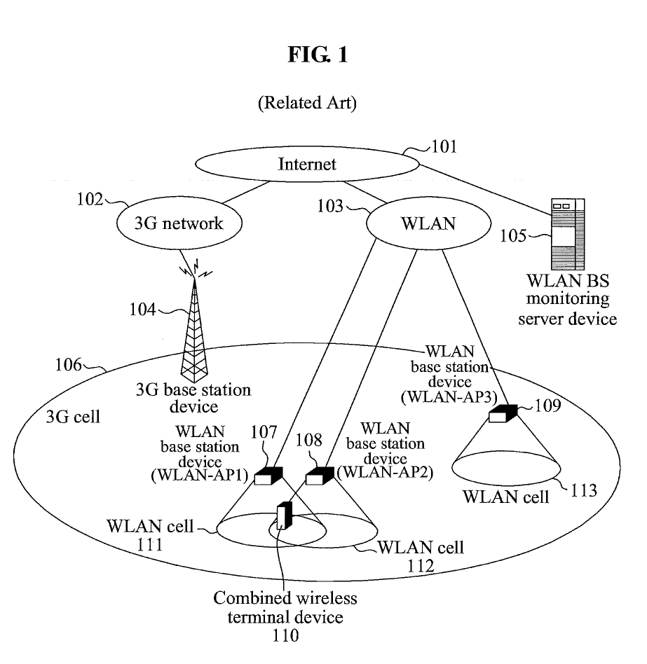

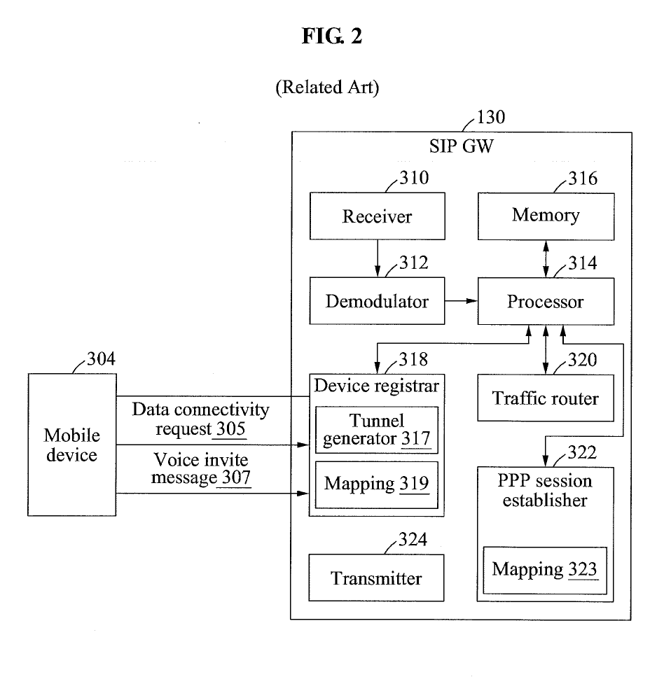

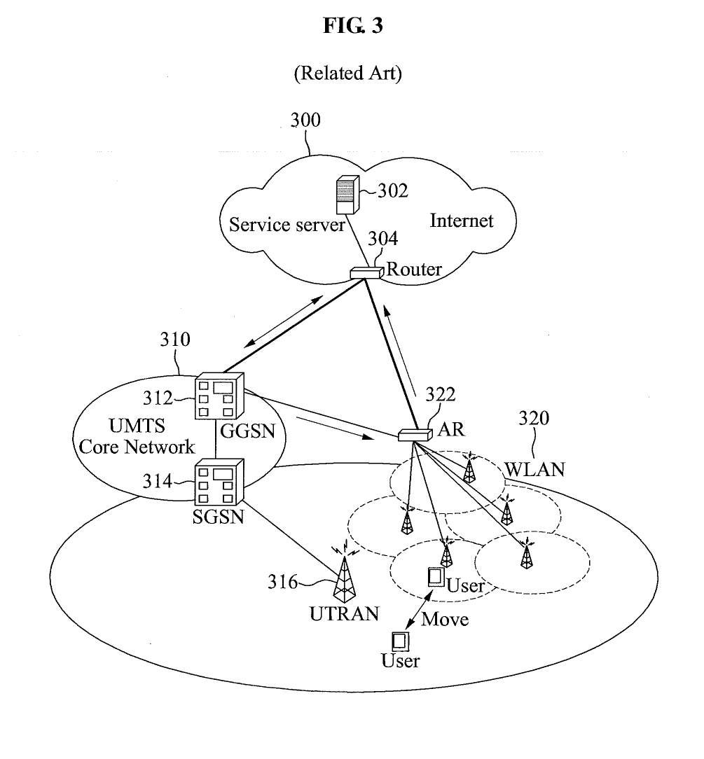

### MODE FOR CARRYING OUT THE INVENTION

The following description only exemplifies the principle of the present invention. Accordingly, even though not clearly described or illustrated in the present specification, those skilled in the art may understand the principle of the present invention and may implement a variety of apparatuses included in the concept and the scope of the present invention.

Also, all of the conditional terms and embodiments described in the present specification are provided to make the concept of the present invention understandable and thus, it should be understood that the present invention is not limited to the particularly enumerated embodiments and states. In addition, all the detailed description related to a predetermined embodiment as well as the description related to the principles, aspects, and embodiments of the present invention should be understood to include structural and functional equivalents thereof.

The aforementioned purposes, features, and advantages will become further apparent through the following description, which are illustrated in the drawings. When it is determined that detailed description related to a related known function or configuration they may make the purpose of the present invention unnecessarily ambiguous in describing the present invention, the detailed description will be omitted here. Hereinafter, embodiments of the present invention will be described with reference to the accompanying drawings.

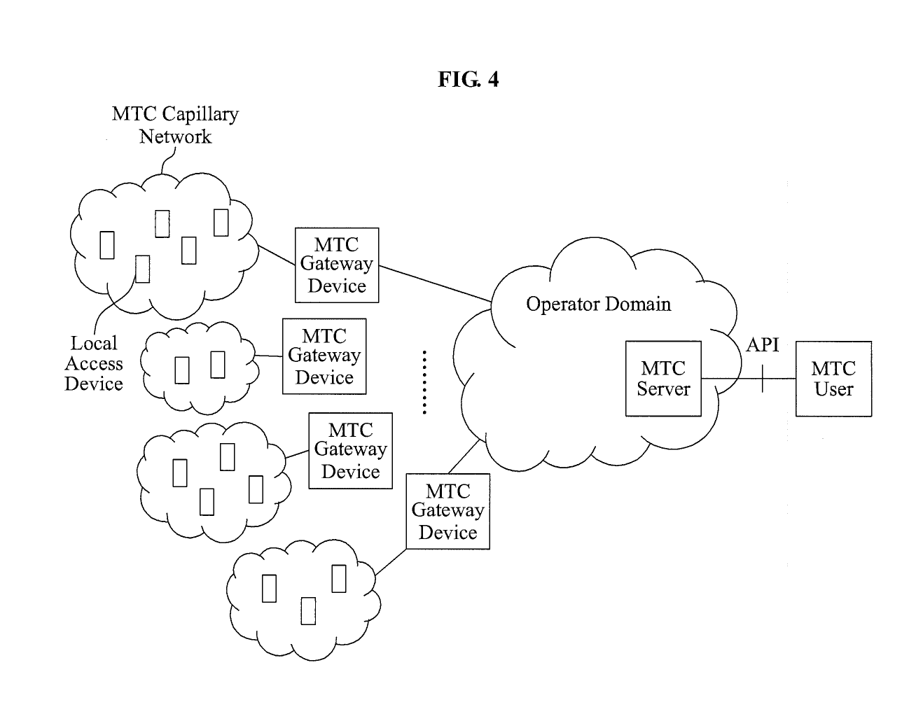

FIG. 4 illustrates an example of a configuration of a machine type communication (MTC) system. MTC is configured based on an MTC server provided to an operator domain to provide an MTC service. The MTC server may be connected to an MTC user through an application program interface (API). A plurality of MTC gateway devices may be connected to the operator domain to relay an MTC service. Each of the plurality of MTC gateway devices may include local access devices and be connected. The local access devices may be wirelessly connected to the MTC devices to provide an MTC service through the MTC gateway devices. Here, the local access devices may configure an MTC capillary network based on a connected MTC gateway device, and may provide a service to an MTC device through the MTC capillary network.

An example of the MTC capillary network may include a wireless local area network (WLAN) as a near-field wireless network. An example of a local access device may include a WLAN access point (AP) device. Also, a typical example of the operator domain may include a 3^{rd} Generation (3G)/4^{th} Generation (4G) communication network. Accordingly, a multimode terminal available in the MTC capillary network and the operator domain may be used for the MTC device for using the MTC system.

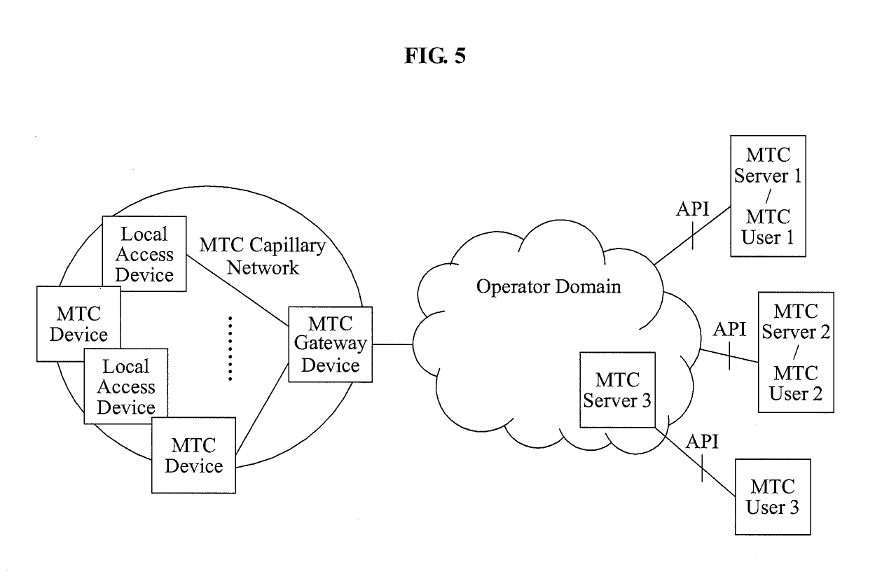

FIG. 5 illustrates another example of a configuration of an MTC system.

As described above with reference to FIG. 4, local access devices wirelessly connected to MTC devices to provide an MTC service through an MTC gateway device are provided within an MTC capillary network. Depending on necessity, the MTC devices may be connected through the MTC gateway, without passing through the local access devices. Here, the MTC gateway device may be connected to an operator domain. As described above with reference to FIG. 4, the operator domain may include an MTC server configured to provide an MTC service and may be connected to an MTC user through an API. Also, a per-user MTC server through an API may be provided outside the operator domain to thereby provide an MTC service provided from a plurality of MTC users.

A typical example of the MTC capillary network of FIGS. 4 and 5 may include a network having a local coverage and a high bandwidth, such as a WLAN. Also, a typical example of the operator domain may include a 3G/4G communication network having a wide coverage and a relatively low bandwidth.

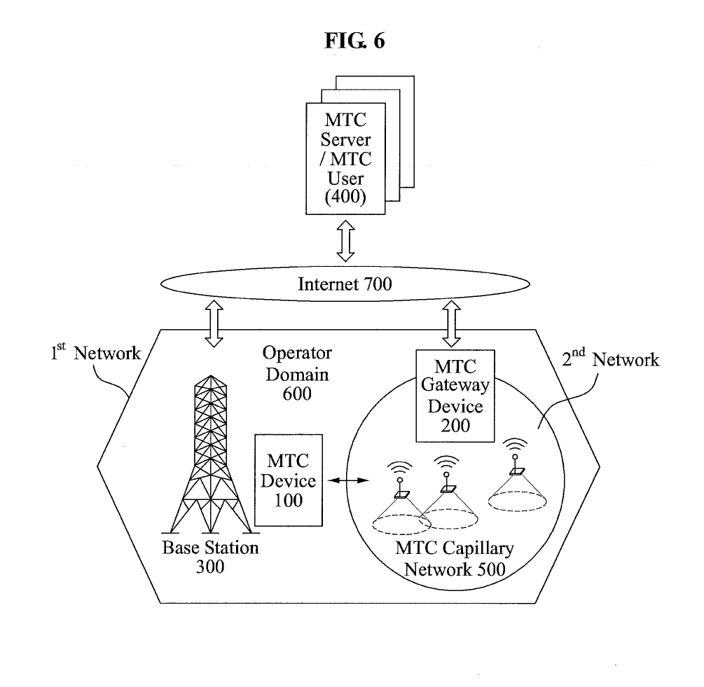

FIG. 6 illustrates the technical spirit of a configuration of an MTC system of the present invention. The MTC system of the present invention may connect an MTC device 100 and an MTC server 400 in a connection environment including a first network of an operator domain 600 and a second network configured using an MTC gateway device 200 configured to manage an MTC capillary network 500. The first network of the operator domain 600 and the second network configured using the MTC gateway device 200 configured to manage the MTC capillary network 500 may be connected to the MTC server 400 over the Internet 700. The MTC device 100 may have predetermined mobility and thus, be selectively connected to the first network or the second network. The first network refers to a communication network having a wide coverage and a low bandwidth, and may be formed based on a base station 300 in the case of a 3G/4G communication network. The second network refers to a network having a local coverage and a high bandwidth. In the case of a WLAN, a local access device may be a wireless AP. The MTC device 100 may be directly connected to the MTC gateway device 200 or may be connected thereto through the local access device. A general MTC capillary network and operator domain may be differentiated from each other in terms of performance and cost, and may also have different performance in terms of an MTC service target and area. Also, in many cases, a network service is locally provided within the operator domain and thus, the MTC capillary network may be regarded as a partial area of the operator domain.

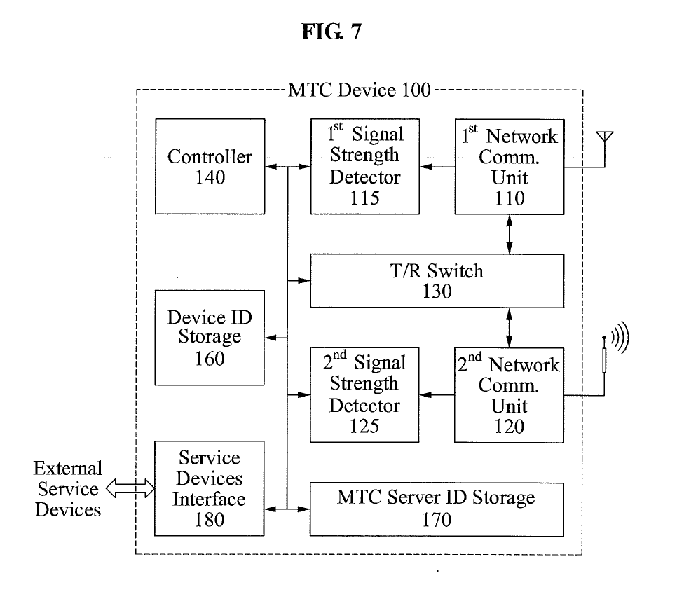

FIG. 7 illustrates a configuration of an MTC device of the present invention. The MTC device 100 of the present invention includes a first network communication unit 110 configured to communicate with a first network having a wide coverage and a low bandwidth and a second network communication unit 120 configured to communicate with a second network having a local coverage and a high bandwidth. A first signal strength detector 115 configured to detect strength of a communication signal of the first network is provided to the first network communication unit 110 to thereby provide the strength of the communication signal of the first network to a controller 140. A second signal strength detector 125 configured to detect strength of a communication signal of the second network is provided to the second network communication unit 120 to thereby provide the strength of the communication signal of the second network to the controller 140. The first network communication unit 110 and the second network communication unit 120 are selected through a transmission/reception (T/R) switch 130 to transmit data provided from the controller 140 as a selected communication unit or to provide received service data.

The controller 140 is connected with an MTC server identifier (ID) storage 170 configured to store an ID of each of at least one MTC server, and a device ID storage 160 configured to store an ID of the MTC device 100. External service devices configured to be provided with an MTC service connect to the controller 140 of the MTC device 100 through a service devices interface 180 to thereby be provided with a service.

The MTC device 100 of the present invention may determine an available state and a connection state of each of the first network and the second network in such a manner that the strength of the communication signal is provided from the first signal strength detector 115 and the second signal strength detector 125 to the controller 140.

The MTC server ID storage 170 may store the ID of the MTC server 400 connected by the operator domain 600 and the MTC gateway device 200 through the Internet 700. The ID of the MTC server 400 may store, as an ID, a universal resource locator (URL), a universal resource identifier (URI), or an Internet protocol (IP) of the MTC server 400. The MTC device 100 may store a fixed device ID in the device ID storage 160. An IP of Internet protocol version 6 (IPv6) may be used as the fixed device ID. Also, the IP of IPv6 and a unique identifier corresponding thereto may be registered in advance to the MTC server 400 and the unique identifier may be used as the device ID. A code and a number capable of identifying the MTC device 100 may be assigned in advance as the unique identifier. The MTC server 400 may extract an IP of the MTC device 100 corresponding to the unique identifier and may provide a service.

Therefore, an MTC service system of the present invention may have no need to manage a separate ID such as a floating IP according to a service connection since a unique ID is assigned for each MTC device 100.

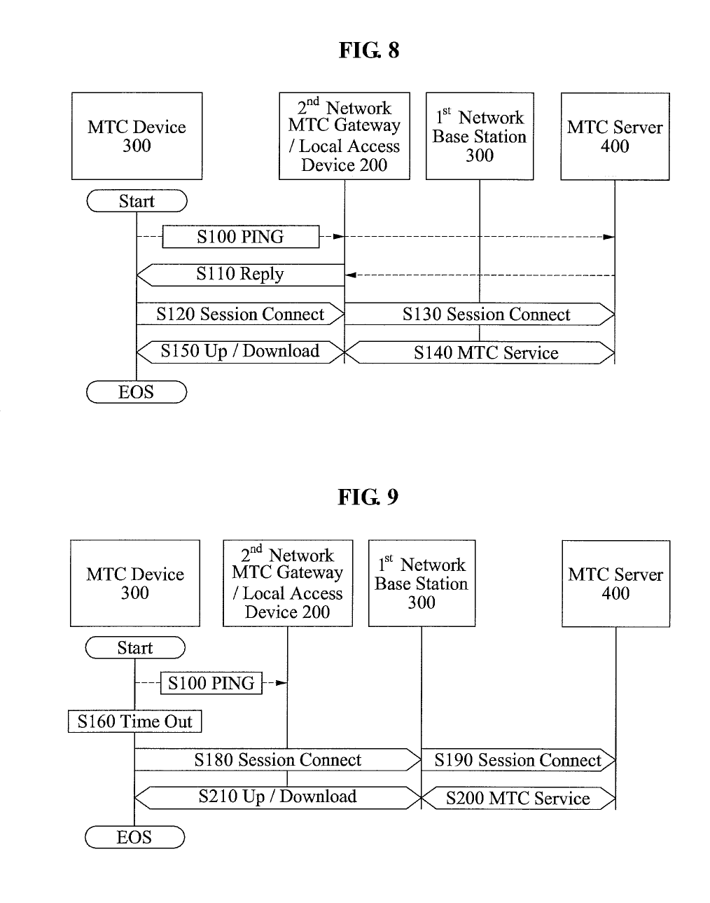

FIG. 8 illustrates an example of an MTC service in a case in which the MTC device 100 of the present invention enters service areas of the first network of the operator domain 600 and the second network configured as the MTC gateway device 200 configured to manage the MTC capillary network 500 and a request for the MTC service occurs. A service of FIG. 8 has a characteristic in that the MTC gateway device 200 and the MTC server 400 may verify the entry of the MTC device with respect to the MTC capillary network 500 that is the service area of the second network.

In operation S100, in response to the request for the MTC service, the MTC device 100 may transmit an ID of the MTC server 400 and a connection request to the MTC gateway device 200 configured to manage an adjacent second network. An example of the connection request to the MTC gateway device 200 may include a method of transmitting the ID of the MTC server 400 desired to be connected and an ID of the MTC device 100 as a packet Internet grouper (PING).

When the MTC gateway device 200 transmits the ID of the MTC device 100 and an IP of the MTC gateway device 200 to the MTC server 400 in response to the connection request, the MTC server 400 may record that the MTC device 100 is under management of the MTC gateway device 200 corresponding to the transmitted IP and the MTC device 100 may receive a reply from the MTC gateway device 200 configured to manage the second network in operation S110.

In operations S120 and S130, the MTC device 100 may perform a session connection to the MTC server 400 through the MTC gateway device 200 from which the response is transmitted, that is, through the second network.

In operation S140, the MTC server 400 may provide the MTC service through the MTC gateway device 200.

In operation S150, the MTC device 100 may perform service uploading and downloading through the MTC gateway device 200. Through this, the MTC service of the present invention may be completed.

FIG. 9 illustrates another example of an MTC service in a case in which the MTC device 100 of the present invention enters service areas of the first network of the operator domain 600 and the second network configured as the MTC gateway device 200 configured to manage the MTC capillary network 500 and a request for the MTC service occurs. A service of FIG. 9 has a characteristic in that the MTC server 400 may verify the entry of the MTC device 100 with respect to the service area of the first network of the operator domain 600.

In operation S100, in response to the request for the MTC service, the MTC device 100 may transmit an ID of the MTC server 400 and a connection request to the MTC gateway device 200 configured to manage an adjacent second network. An example of the connection request to the MTC gateway device 200 may include a method of transmitting the ID of the MTC server 400 desired to be connected and an ID of the MTC device 100 as a PING.

In operation S160, a reply may not be received by the MTC device 100 from the MTC gateway device 200 within a predetermined period of time in response to the connection request.

In this case, in operations S180 and S190, the MTC device 100 may select the first network and perform a session connection to the MTC server 400 through the base station 300 configured to manage the first station.

In operation S200, the MTC server 400 may provide an MTC service through the base station 300 configured to manage the first network.

In operation S210, the MTC device 100 may perform service uploading and downloading through the base station 300. Through this, the MTC service of the present invention may be completed.

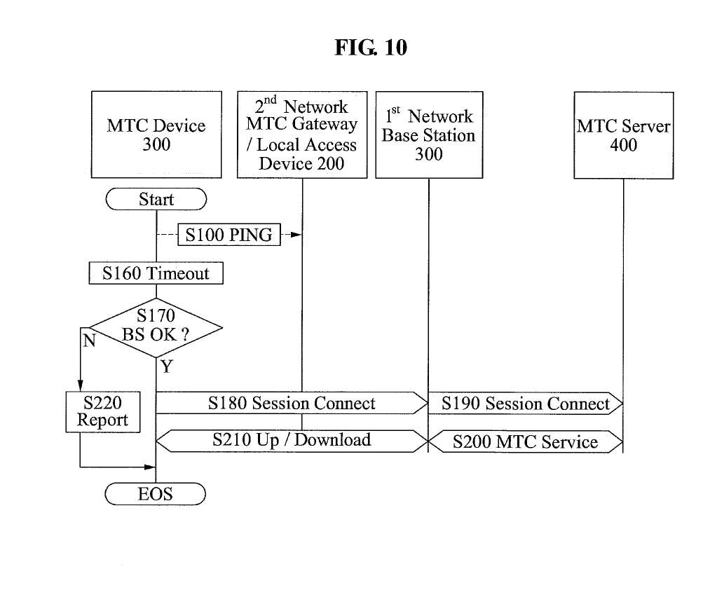

FIG. 10 illustrates still another example of an MTC service in a case in which the MTC device 100 of the present invention enters service areas of the first network of the operator domain 600 and the second network configured as the MTC gateway device 200 configured to manage the MTC capillary network 500 and a request for the MTC service occurs. A service of FIG. 10 has a characteristic in that the MTC server 400 may verify the entry of the MTC device 100 with respect to the service area of the first network of the operator domain 600.

In operation S100, in response to the request for the MTC service, the MTC device 100 may transmit an ID of the MTC server 400 and a connection request to the MTC gateway device 200 configured to manage an adjacent second network. An example of the connection request to the MTC gateway device 200 may include a method of transmitting the ID of the MTC server 400 desired to be connected and an ID of the MTC device 100 as a PING.

In operation S160, a reply may not be received by the MTC device 100 from the MTC gateway device 200 within a predetermined period of time in response to the connection request.

In this case, in operations S170, the MTC device 100 may select the first network and may determine whether strength of a signal of the base station 300 configured to manage the first network is greater than or equal to a tolerance value using the first signal strength detector 115 included in the MTC device 100.

When the strength of the signal of the base station 300 configured to manage the first network is determined to be greater than or equal to the tolerance value in operation S170, the MTC device 100 may perform a session connection to the MTC server 400 through the base station 300 configured to manage the first station in operations S180 and S190.

In operation S200, the MTC server 400 may provide an MTC service through the base station 300 configured to manage the first network.

In operation S210, the MTC device 100 may perform service uploading and downloading through the base station 300. Through this, the MTC service of the present invention may be completed.

When the strength of the signal of the base station 300 configured to manage the first network is determined to be less than the tolerance value in operation S170, the MTC device 100 may report blockage of a network connection to a user in operation S220, and may terminate a service after operation S220 or may repeat a process starting from operation S100.

In the MTC service of the present invention described above with reference to FIGS. 8 through 10, the MTC device 100 may verify and connect to an available network that is positioned within the service areas of the first network and the second network, to thereby be provided with the MTC service. In the above configuration in which the MTC device 100 is provided with the MTC service, required is a technology that enables the MTC device 100 to detect a variation and to maintain a continuous service through another available network in a case in which a network service environment varies, that is, in a case in which a connection state of a network providing a service varies.

A case in which a connection state of a network providing a service to the MTC device 100 may include a case in which the MTC device 100 moves to the service area of the second network while receiving a service through connection to the first network, and a case in which the MTC device 100 hands off the service area of the second network to the service area of the service area while receiving a service through connection to the second network.

As described above, a typical example of an operator domain as the first network may include 3G/4G networks having a wide coverage and a relatively low bandwidth. Also, a typical example of an MTC capillary network as the second network may include a network having a local coverage and a relatively high bandwidth, such as a WLAN.

As described above with reference to FIG. 6, in many cases, a network service is locally provided within the operator domain and thus, the MTC capillary network and thus, may be regarded as a partial area of the operator domain.

Therefore, according to the present invention, in a case in which the MTC device 100 moves to the service area of the second network while receiving a service through connection to the first network, the MTC device 100 may maintain the service as is and thus, a continuous service may be regarded to be provided without performing a separate action. In a case in which the MTC device 100 hands off he service area of the second network to the service area of the first network while receiving a service through connection to the second network, a continuous service may be provided by enabling the MTC device 100 to switch a connection from the second network to the first network.

Hereinafter, a service method in a case in which the MTC device 100 hands off the service area of the second network to the service area of the service area while receiving a service through connection to the second network will be described.

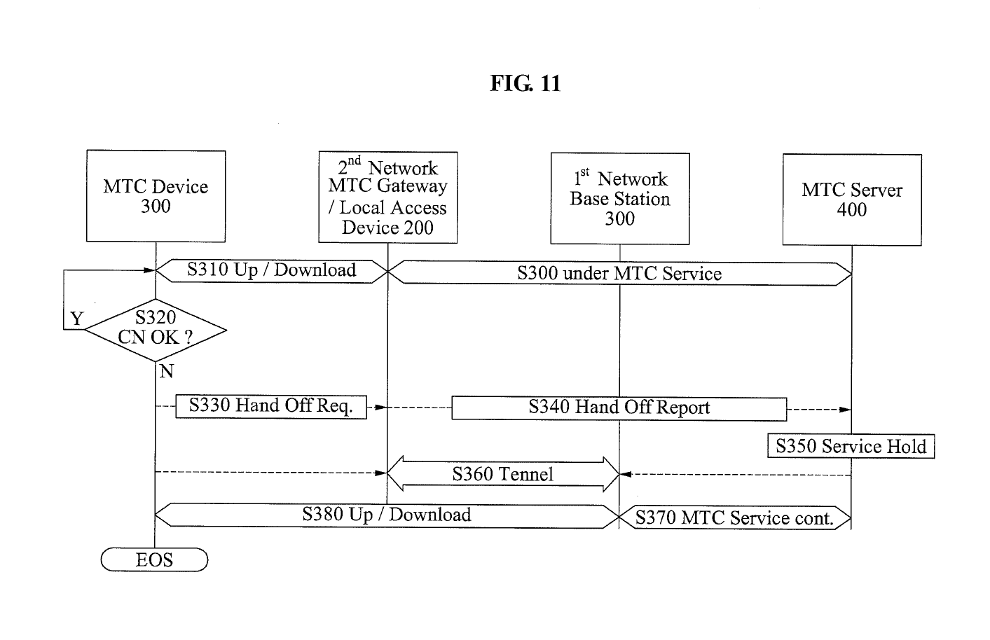

FIG. 11 illustrates an example of an MTC service in a case in which the MTC device 100 of the present invention hands off a service area of a second network while receiving the MTC service in the service area of the second network configured as the MTC gateway device 200 configured to manage the MTC capillary network 500. A service of FIG. 11 has a characteristic in that the MTC gateway device 200 and the MTC server 400 may verify that the MTC device 100 is handing off the MTC capillary network 500 that is the service area of the second network and thereby provide a continuous service.

In operations S300 and S310, the MTC device 100 may be receiving a service from the MTC server 400 through the MTC gateway device 200.

In operation S320, the MTC device 100 may receive strength of a communication signal from the second signal strength detector 125 through the controller 140, and may determine whether a connection state of the MTC capillary network 500 corresponding to the second network is available.

When the strength of the communication signal of the MTC capillary network 500 is greater than or equal to a tolerance value and the connection state is determined to be available in operation S320, the MTC device 100 may continuously perform operations S300 and S5310.

When the strength of the communication signal of the MTC capillary network 500 is less than the tolerance value and the connection state is determined to be unavailable in operation S320, the MTC device 100 may transmit a hand off request to the MTC gateway device 200 of the second network in a current connection state in operation S330.

In operation S340, the MTC gateway device 200 may transmit a hand off report indicating that the MTC device 100 hands off a service area of the MTC gateway device 200 of the second network together with the ID of the MTC device 100 in response to the hand off request of operation S330.

In this case, in operation S350, the MTC server 400 may temporarily hold a service.

In operation S360, the MTC server 400 may perform a tunneling operation, that is, provide a tunnel between the MTC gateway device 200 of the second network being currently serviced and the base station 300 of the first network.

In operations S370 and S380, the MTC server 400 may continue the service temporarily held in S350 using the ID of the MTC device 100 through the base station 300 of the first network. Through this, the MTC service may be continuously provided.

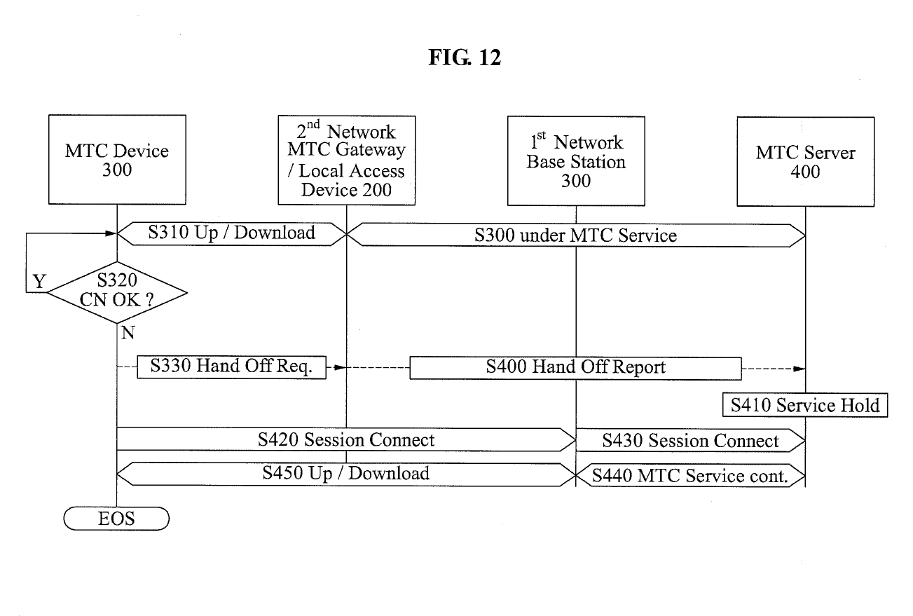

FIG. 12 illustrates another example of an MTC service in a case in which the MTC device 100 of the present invention hands off a service area of a second network while receiving the MTC service in the service area of the second network configured as the MTC gateway device 200 configured to manage the MTC capillary network 500. A service of FIG. 12 has a characteristic in that the MTC gateway device 200 and the MTC server 400 may verify that the MTC device 100 is handing off the MTC capillary network 500 that is the service area of the second network and thereby provide a continuous service.

In operations S300 and S310, the MTC device 100 may be receiving a service from the MTC server 400 through the MTC gateway device 200.

In operation S320, the MTC device 100 may receive strength of a communication signal from the second signal strength detector 125 through the controller 140, and may determine whether a connection state of the MTC capillary network 500 corresponding to the second network is available.

When the strength of the communication signal of the MTC capillary network 500 is greater than or equal to a tolerance value and the connection state is determined to be available in operation S320, the MTC device 100 may continuously perform operations S300 and S310.

When the strength of the communication signal of the MTC capillary network 500 is less than the tolerance value and the connection state is determined to be unavailable in operation S320, the MTC device 100 may transmit a hand off request to the MTC gateway device 200 of the second network in a current connection state in operation S330.

In operation S400, the MTC gateway device 200 may transmit a hand off report indicating that the MTC device 100 hands off a service area of the MTC gateway device 200 of the second network together with the ID of the MTC device 100 in response to the hand off request of operation S330.

In this case, in operation S410, the MTC server 400 may temporarily hold the MTC service with respect to the ID of the MTC device 100.

In operations S420 and S430, the MTC device 100 may switch a connection network to the base station 300 of the first network and may transmit the ID of the MTC device 100 and MTC service information to the MTC server 400 through the first network, thereby performing a session connection.

In operations S440 and S450, the MTC server 400 may continue the MTC service temporarily held in operation S410 using the ID of the MTC device 100 through the base station 300 of the first network. Through this, the MTC service may be continuously provided.

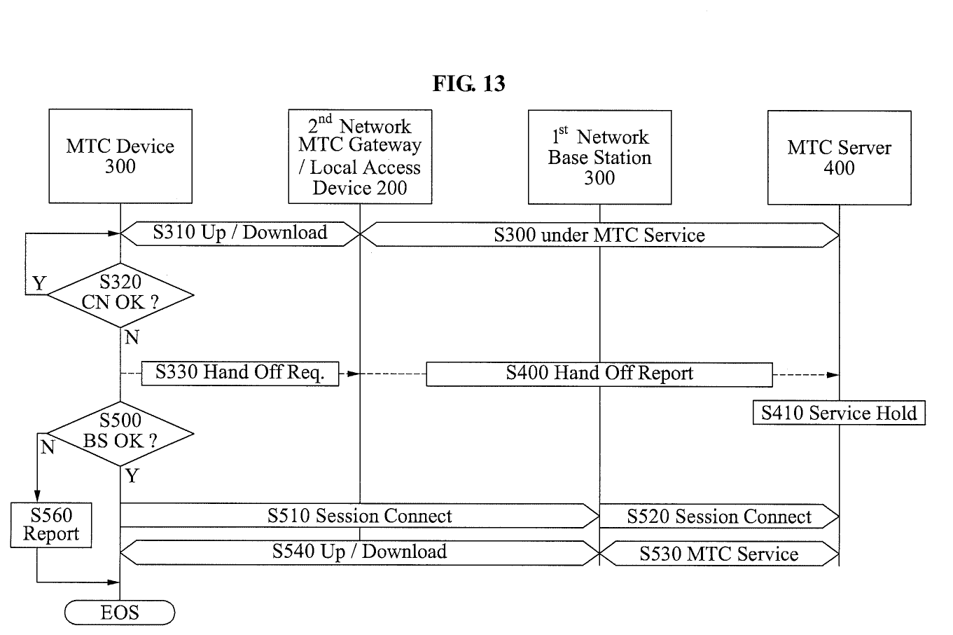

FIG. 13 illustrates still another example of an MTC service in a case in which the MTC device 100 of the present invention hands off a service area of a second network while receiving the MTC service in the service area of the second network configured as the MTC gateway device 200 configured to manage the MTC capillary network 500. A service of FIG. 13 has a characteristic in that the MTC gateway device 200 and the MTC server 400 may verify that the MTC device 100 is handing off the MTC capillary network 500 that is the service area of the second network and thereby provide a continuous service.

In operations S300 and S310, the MTC device 100 may be receiving a service from the MTC server 400 through the MTC gateway device 200 in the service area of the second network.

In operation S320, the MTC device 100 may receive strength of a communication signal from the second signal strength detector 125 through the controller 140, and may determine whether a connection state of the MTC capillary network 500 corresponding to the second network is available.

When the strength of the communication signal of the MTC capillary network 500 is greater than or equal to a tolerance value and the connection state is determined to be available in operation S320, the MTC device 100 may continuously perform operation S300 and S310.

When the strength of the communication signal of the MTC capillary network 500 is less than the tolerance value and the connection state is determined to be unavailable in operation S320, the MTC device 100 may transmit a hand off request to the MTC gateway device 200 of the second network in a current connection state in operation S330.

In operation S400, the MTC gateway device 200 may transmit a hand off report indicating that the MTC device 100 hands off a service area of the MTC gateway device 200 of the second network together with the ID of the MTC device 100 in response to the hand off request of operation S330.

In this case, in operation S410, the MTC server 400 may temporarily hold the MTC service with respect to the ID of the MTC device 100.

In operation S500, the MTC server 400 may select the first network and may determine whether strength of a signal of the base station 300 configured to manage the to first network is greater than or equal to the tolerance value using the first signal strength detector 115 included in the MTC device 100.

When the strength of the signal of the base station 300 configured to manage the first network is determined to be greater than or equal to the tolerance value in operation S500, the MTC device 100 may transmit the ID of the MTC device 100 and MTC service information to the MTC server 400 through the first network, thereby performing a session connection in operations S510 and S520.

In operations S530 and S540, the MTC server 400 may continue the MTC service temporarily held in operation S410 using the ID of the MTC device 100 through the base station 300 of the first network. Through this, the MTC service may be continuously provided.

When the strength of the signal of the base station 300 configured to manage the first network is determined to be less than the tolerance value in operation S500, the MTC device 100 may report blockage of a network connection to a user in operation S560, and may terminate a service after operation S560 or may repeat a process starting from operation S500.

As described above, according to an MTC device of the present invention and a method of providing an MTC service, the MTC device 100 may be configured to use an IP of IPv6 as a fixed device ID, and to register the IP of IPv6 and a unique identifier corresponding thereto as a device ID in advance to the MTC server 400 and thereby use the unique identifier as the device ID. Accordingly, there is no need to manage a separate ID such as a floating IP according to a service connection since a unique ID is assigned for each MTC device 100. Also, according to the MTC device of the present invention and a method of providing an MTC service, an MTC gateway device and an MTC server may verify the entry and hand off of the MTC device with respect to the to MTC capillary network, thereby enabling an efficient MTC service.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

EXPLANATION OF REFERENCE NUMERALS

| | |
|---|---|
| 100: MTC device | 110: First network communication unit |
| 115: First signal detector | 120: Second network communication unit |
| 125: Second signal detector | 130: T/R switch |
| 140: Controller | 160: Device ID storage |
| 170: MTC server ID storage | 180: Service devices interface |
| 200: MTC gateway device | 300: Base station |
| 400: MTC server | 500: MTC capillary network |
| 600: Operator domain | 700: Internet |

1. A machine type communication (MTC) device in an MTC system for providing a service by providing a first network having a wide coverage and a low bandwidth and a second network having a local coverage and a high bandwidth and by connecting an MTC device 100 and an MTC server 400, the MTC device 100 comprising:
a first network communication unit 110 configured to communicate with the first network having the wide coverage and the low bandwidth; and
a second network communication unit 120 configured to communicate with the second network having the local coverage and the high bandwidth,
wherein a first signal strength detector 115 configured to detect strength of a communication signal of the first network is provided to the first network communication unit 110 to thereby provide the strength of the communication signal of the first network to a controller 140,
a second signal strength detector 125 configured to detect strength of a communication signal of the second network is provided to the second network communication unit 120 to thereby provide the strength of the communication signal of the second network to the controller 140,
the first network communication unit 110 and the second network communication unit 120 are selected through a transmission/reception switch 130 to transmit data provided from the controller 140 as a selected communication unit or to provide received service data,
the controller 140 is connected with an MTC server identifier (ID) storage 170 configured to store an ID of each of at least one MTC server, and a device ID storage 160 configured to store an ID of the MTC device 100, and
external service devices configured to be provided with an MTC service are connected to the controller 140 of the MTC device 100 through a service devices interface 180 to thereby be provided with a service.

2. The MTC device of claim 1, wherein
the MTC server ID storage 170 stores the ID of the MTC server 400 connected by an operator domain 600 and an MTC gateway device 200 through the Internet, and
the ID of the MTC server 400 stores, as an ID, a universal resource locator (URL), a universal resource identifier (URI), or an Internet protocol (IP) of the MTC server 400.

3. The MTC device of claim 1, wherein the device ID storage 160 stores, as a device ID, an IP of Internet protocol version 6 (IPv6) assigned to the MTC device 100.

4. The MTC device of claim 1, wherein
the device ID storage 160 stores a device ID assigned to the MTC device 100, and
an IP of IPv6 and a unique identifier corresponding thereto are registered in advance to the MTC server 400 and the unique identifier is used as the device ID.

5. The MTC device of claim 4, wherein a code and a number capable of identifying the MTC device 100 is assigned in advance as the unique identifier, and the MTC server 400 is configured to extract an IP of the MTC device 100 corresponding to the unique identifier and to provide a service.

6. A method of providing a machine type communication (MTC) service in a case in which, in an MTC system for providing a service by providing a first network having a wide coverage and a low bandwidth and a second network having a local coverage and a high bandwidth and by connecting an MTC device 100 and an MTC server 400, the MTC device 100 enters service areas of the first network of an operator domain 600 and the second network configured as an MTC gateway device 200 configured to manage an MTC capillary network 500 and a request for the MTC service occurs, the method comprising:
operation S100 of transmitting, by the MTC device 100, an ID of the MTC server 400 and a connection request to the MTC gateway device 200 configured to manage an adjacent second network, in response to the request for the MTC service;
operation S110 of, when the MTC gateway device 200 transmits an ID of the MTC device 100 and an IP of the MTC gateway device 200 to the MTC server 400 in response to the connection request, recording, by the MTC server 400, that the MTC device 100 is under management of the MTC gateway device 200 corresponding to the transmitted IP and receiving, by the MTC device 100, a reply from the MTC gateway device 200 configured to manage the second network;
operations S120 and S130 of performing, by the MTC device 100, a session connection to the MTC server 400 through the MTC gateway device 200 from which the response is transmitted, that is, through the second network;
operation S140 of providing, by the MTC server 400, the MTC service through the MTC gateway device 200; and
operation S150 of performing, by the MTC device 100, service uploading and downloading through the MTC gateway device 200.

7. The method of claim 6, wherein, in operation S100, as the connection request transmitted from the MTC device 100 to the MTC gateway device 200 configured to manage the adjacent second network together with the ID of the MTC gateway device 200, the MTC device 100 is configured to transmit the ID of the MTC server 400 desired to be connected and the ID of the MTC device 100 as a packet Internet grouper (PING).

8. A method of providing a machine type communication (MTC) service in a case in which, in an MTC system for providing a service by providing a first network having a wide coverage and a low bandwidth and a second network having a local coverage and a high bandwidth and by connecting an MTC device 100 and an MTC server 400, the MTC device 100 enters service areas of the first network of an operator domain 600 and the second network configured as an MTC gateway device 200 configured to manage an MTC capillary network 500 and a request for the MTC service occurs, the method comprising:
operation S100 of transmitting, by the MTC device 100, an ID of the MTC server 400 and a connection request to the MTC gateway device 200 configured to manage a network;
operation S160 of not receiving, by the MTC device 100, a reply from the MTC gateway device 200 within a predetermined period of time in response to the connection request;
operations S180 and S190 of selecting, by the MTC device 100, the first network and performing a session connection to the MTC server 400 through a base station 300 configured to manage the first station;
operation S200 of providing, by the MTC server 400, the MTC service through the base station 300 configured to manage the first network; and
operation S210 of performing, by the MTC device 100, service uploading and downloading through the base station 300.

9. The method of claim 8, wherein, in operation S100, as the connection request transmitted from the MTC device 100 to the MTC gateway device 200 configured to manage the adjacent second network together with the ID of the MTC gateway device 200, the MTC device 100 is configured to transmit the ID of the MTC server 400 desired to be connected and the ID of the MTC device 100 as a packet Internet grouper (PING).

10. A method of providing a machine type communication (MTC) service in a case in which, in an MTC system for providing a service by providing a first network having a wide coverage and a low bandwidth and a second network having a local coverage and a high bandwidth and by connecting an MTC device 100 and an MTC server 400, the MTC device 100 enters service areas of the first network of an operator domain 600 and the second network configured as an MTC gateway device 200 configured to manage an MTC capillary network 500 and a request for the MTC service occurs, the method comprising:
operation S110 of transmitting, by the MTC device 100, an ID of the MTC server 400 and a connection request to the MTC gateway device 200 configured to manage an adjacent second network in response to the request for the MTC service;
operation S160 of not receiving, by the MTC device 100, a reply from the MTC gateway device 200 within a predetermined period of time in response to the connection request;
operation S170 of selecting, by the MTC device 100, the first network and determining whether strength of a signal of the base station 300 configured to manage the first network is greater than or equal to a tolerance value using a first signal strength detector 115 included in the MTC device 100;
operations S180 and S190 of, when the strength of the signal of the base station 300 configured to manage the first network is determined to be greater than or equal to the tolerance value in operation S170, performing, by the MTC device 100, a session connection to the MTC server 400 through the base station 300 configured to manage the first station;
operation S200 of providing, by the MTC server 400, the MTC service through the base station 300 configured to manage the first network; and
operation S210 of performing, by the MTC device 100, service uploading and downloading through the base station 300.

11. The method of claim 10, wherein, in operation S100, as the connection request transmitted from the MTC device 100 to the MTC gateway device 200 configured to manage the adjacent second network together with the ID of the MTC gateway device 200, the MTC device 100 is configured to transmit the ID of the MTC server 400 desired to be connected and the ID of the MTC device 100 as a packet Internet grouper (PING).

12. The method of claim 10, wherein when the strength of the signal of the base station 300 configured to manage the first network is determined to be less than the tolerance value in operation S170, the MTC device 100 is configured to perform operation S220 of reporting blockage of a network connection to a user and to terminate a service after operation S220.

13. The method of claim 10, wherein when the strength of the signal of the base station 300 configured to manage the first network is determined to be less than the tolerance value in operation S170, the MTC device 100 is configured to perform operation S220 of reporting blockage of a network connection to a user and to repeat a process starting from operation S100.

14. A method of providing a machine type communication (MTC) service in a case in which, in an MTC system for providing a service by providing a first network having a wide coverage and a low bandwidth and a second network having a local coverage and a high bandwidth and by connecting an MTC device 100 and an MTC server 400, the MTC device 100 hands off a service area of the second network while receiving the MTC service from the MTC server 400 in the service area of the second network, the method comprising:
operations S300 and S310 of receiving, by the MTC device 100, a service from the MTC server 400 through the MTC gateway device 200;
operation S320 of receiving, by the MTC device 100, strength of a communication signal from a second signal strength detector 125 through a controller 140, and determining whether a connection state of an MTC capillary network corresponding to the second network is available;
operations S300 and S310 being continuously performed by the MTC device 100 when the strength of the communication signal of the MTC capillary network is greater than or equal to a tolerance value and the connection state is determined to be available in operation S320;
operation S330 of, when the strength of the communication signal of the MTC capillary network is less than the tolerance value and the connection state is determined to be unavailable in operation S320, transmitting, by the MTC device 100, a hand off request to the MTC gateway device 200 of the second network in a current connection state;
operation S340 of transmitting, by the MTC gateway device 200, a hand off report indicating that the MTC device 100 hands off a service area of the MTC gateway device 200 of the second network together with the ID of the MTC device 100 in response to the hand off request of operation S330;
operation S350 of temporarily holding, by the MTC server 400, a service;
operation S360 of providing, by the MTC server 400, a tunnel between the MTC gateway device 200 of the second network being currently serviced and a base station 300 of the first network; and
operations S370 and S380 of continuing, by the MTC server 400, the service temporarily held in operation S350 using the ID of the MTC device 100 through the base station 300 of the first network.

15. A method of providing a machine type communication (MTC) service in a case in which, in an MTC system for providing a service by providing a first network having a wide coverage and a low bandwidth and a second network having a local coverage and a high bandwidth and by connecting an MTC device 100 and an MTC server 400, the MTC device 100 hands off a service area of the second network while receiving the MTC service from the MTC server 400 in the service area of the second network, the method comprising:
operations S300 and S310 of receiving, by the MTC device 100, a service from the MTC server 400 through the MTC gateway device 200;
operation S320 of receiving, by the MTC device 100, strength of a communication signal from a second signal strength detector 125 through a controller 140, and determining whether a connection state of an MTC capillary network corresponding to the second network is available;
operations S300 and S310 being continuously performed by the MTC device 100 when the strength of the communication signal of the MTC capillary network is greater than or equal to a tolerance value and the connection state is determined to be available in operation S320;
operation S330 of, when the strength of the communication signal of the MTC capillary network is less than the tolerance value and the connection state is determined to be unavailable in operation S320, transmitting, by the MTC device 100, a hand off request to the MTC gateway device 200 of the second network in a current connection state;
operation S400 of transmitting, by the MTC gateway device 200, a hand off report indicating that the MTC device 100 hands off a service area of the MTC gateway device 200 of the second network together with the ID of the MTC device 100 in response to the hand off request of operation S330;
operation S410 of temporarily holding, by the MTC server 400, the MTC service with respect to the ID of the MTC device 100;
operations S420 and S430 of switching, by the MTC device 100, a connection network to a base station 300 of the first network, and transmitting the ID of the MTC device 100 and MTC service information to the MTC server 400 through the first network, thereby performing a session connection; and
operations S440 and 450 of continuing, by the MTC server 400, the MTC service temporarily held in operation S410 using the ID of the MTC device 100 through the base station 300 of the first network.

16. A method of providing a machine type communication (MTC) service in a case in which, in an MTC system for providing a service by providing a first network having a wide coverage and a low bandwidth and a second network having a local coverage and a high bandwidth and by connecting an MTC device 100 and an MTC server 400, the MTC device 100 hands off a service area of the second network while receiving an MTC service from the MTC server 400 in the service area of the second network, the method comprising:
operations S300 and S310 of receiving, by the MTC device, a service from the MTC server 400 through the MTC gateway device 200 in the service area of the second network;
operation S320 of receiving, by the MTC device 100, strength of a communication signal from a second signal strength detector 125 through a controller 140, and determining whether a connection state of an MTC capillary network corresponding to the second network is available;
operations S300 and S310 being continuously performed by the MTC device 100 when the strength of the communication signal of the MTC capillary network is greater than or equal to the tolerance value and the connection state is determined to be available in operation S320;
operation S330 of, when the strength of the communication signal of the MTC capillary network is less than the tolerance value and the connection state is determined to be unavailable in operation S320, transmitting, by the MTC device 100, a hand off request to the MTC gateway device 200 of the second network in a current connection state;
operation S400 of transmitting, by the MTC gateway device, a hand off report indicating that the MTC device 100 hands off a service area of the MTC gateway device 200 of the second network together with the ID of the MTC device 100 in response to the hand off request of operation S330,
operation S410 of temporarily holding, by the MTC server 400, the MTC service with respect to the ID of the MTC device 100;
operation S500 of selecting, by the MTC device 100, the first network and determining whether strength of a signal of a base station 300 configured to manage the first network is greater than or equal to the tolerance value using a first signal strength detector 115 included in the MTC device 100;
operations S510 and S520 of, when the strength of the signal of the base station 300 configured to manage the first network is determined to be greater than or equal to the tolerance value in operation S500, transmitting, by the MTC device 100, the ID of the MTC device 100 and MTC service information to the MTC server 400 through the first network, thereby performing a session connection; and
operations S530 and S540 of continuing, by the MTC server 400, the MTC service temporarily held in operation S410 using the ID of the MTC device 100 through the base station 300 of the first network.

17. The method of claim 16, wherein when the strength of the signal of the base station 300 configured to manage the first network is determined to be less than the tolerance value in operation S500, the MTC device 100 is configured to perform operation S560 of reporting blockage of a network connection to a user and to terminate a service after operation S560.

18. The method of claim 16, wherein when the strength of the signal of the base station 300 configured to manage the first network is determined to be less than the tolerance value in operation S500, the MTC device 100 is configured to perform operation S560 of reporting blockage of a network connection to a user and to repeat a process starting from operation S500.
